(19) United States
(12) Patent Application Publication
(10) Pub. No.: US 2018/0286218 A1
(43) Pub. Date: Oct. 4, 2018

(54) WIRELESS FIRE-PROTECTION SYSTEM

(71) Applicant: Cease Fire, LLC, Vancouver, WA (US)

(72) Inventors: Cody Kitterman, Vancouver, WA (US); Louis Vanderwel, Battleground, WA (US)

(21) Appl. No.: 15/943,454

(22) Filed: Apr. 2, 2018

Related U.S. Application Data
(60) Provisional application No. 62/480,836, filed on Apr. 3, 2017.

(51) Int. Cl. G08B 27/00; A62C 35/68; G08B 26/00; G08B 17/06

(52) U.S. Cl. CPC G08B 27/005; G08B 17/06; G08B 26/007; A62C 35/68

(57) ABSTRACT

A system including a pressure vessel, an actuator, a wireless transmitter, a wireless receiver, and a battery. The actuator is at an outlet of the pressure vessel and is configured to, when activated, release fire-suppression agent held under pressure within the pressure vessel. The wireless transmitter is remote from the actuator and is configured to wirelessly transmit an activation signal. The wireless receiver is coupled to the actuator and is configured to wirelessly receive the activation signal from the wireless transmitter. The battery is coupled to the wireless receiver and is configured to provide electrical power to the wireless receiver.

### CROSS-REFERENCES TO RELATED APPLICATIONS

This patent application claims the benefit of provisional Application No. 62/480,836 filed Apr. 3, 2017. That application is incorporated in this patent application by this reference.

### FIELD OF THE INVENTION

This disclosure is directed to a system and methods for activating a fire-protection system, especially a fire-protection system that utilizes a fire-suppression agent under pressure.

### BACKGROUND

Fire-suppression systems are suggested or required by law in some applications because such systems help to reduce damage to property, including equipment, and risk to personnel. These systems typically use water, chemicals (such as dry-chemical agents), or so-called clean agents (such as carbon dioxide) to extinguish or reduce a fire by, for example, depriving the fire of the oxygen, fuel, or heat, or by otherwise inhibiting the combustion reaction.

Conventional water systems typically include a water conduit that transports water between a water main and one or more sprinkler heads. The sprinkler head discharges water from the water conduit when the sprinkler head is subjected to a predetermined temperature. Oftentimes, the sprinkler head includes a frangible bulb containing a temperature-sensitive fluid. When subjected to the predetermined temperature, the temperature-sensitive fluid expands, causing the frangible bulb to break, thereby releasing a stopper and allowing water to flow through the sprinkler head. When operating correctly, water systems discharge water in the vicinity of the heat source, generally presumed to be a fire, that is subjecting the sprinkler head to the predetermined temperature, thereby extinguishing or reducing the fire.

Conventional dry chemical systems and clean agent systems typically operate in a similar fashion and may likewise use a sprinkler head or a nozzle to discharge the fire-suppression agent from a reservoir when the sprinkler head is subjected to a predetermined temperature.

Embodiments of the disclosed systems and methods address shortcomings in the prior art.

### BRIEF DESCRIPTION OF THE DRAWINGS

FIG. 1 is a diagram of a wireless fire-protection system, according to embodiments.

FIG. 2 is a diagram of an example of a fire-alarm pull-station, according to embodiments.

FIG. 3 is a diagram of an example of a fire control panel, according to embodiments.

FIG. 4 is a diagram of a wireless fire-protection system, according to embodiments.

### DETAILED DESCRIPTION

As described herein, embodiments are directed to a wireless fire-protection system configured to remotely activate a pressure vessel holding a fire-suppression agent under pressure. The pressure vessel is activated through an actuator at an outlet of the pressure vessel and a wireless receiver that is coupled to the actuator. The wireless receiver and actuator may both be battery powered, meaning that the wireless receiver and actuator need not be coupled to grid power. This allows the wireless receiver and actuator to be installed without requiring an electrician to wire the receiver to the electrical grid. Also, since the fire-suppression agent is preferably a dry-chemical agent or a fire-suppression gel, embodiments of the system need not be linked to a water line, further facilitating installation. Accordingly, embodiments of the system may be installed in locations where grid power or water lines are not available or feasible. In addition, since the pressure vessel, actuator, and wireless receiver may be connected into a single unit, in versions of the system these components may be installed in one piece, further facilitating installation.

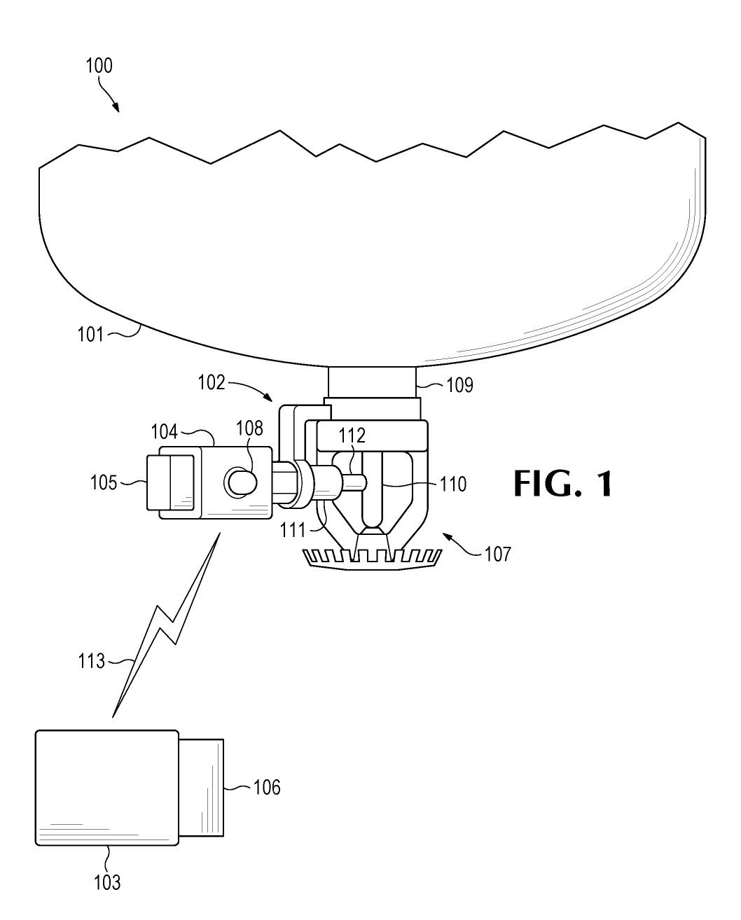

FIG. 1 is a diagram showing portions of a wireless fire-protection system according to embodiments. As illustrated in FIG. 1, a wireless fire-protection system 100 may include a pressure vessel 101, an actuator 102, a wireless transmitter 103, a wireless receiver 104, a receiver battery 105, a transmitter battery 106, a sprinkler head 107, and a visual indicator 108 or LED.

For clarity, FIG. 1 shows only a portion of the pressure vessel 101. The pressure vessel 101 may be, for example, a cylinder, bottle, canister, tank, or other such container. The pressure vessel 101 has an outlet 109 of the pressure vessel 101 and is configured to hold fire-suppression agent under pressure within the pressure vessel 101. The fire-suppression agent may be held, for example, between about 150 pounds per square inch (psi) and about 160 psi within the pressure vessel 101. Preferably, the fire-suppression agent is a dry-chemical agent or a fire-suppression gel. The fire-suppression gel may be, for example, a thixotropic gel.

The actuator 102 may be at the outlet 109 of the pressure vessel 101. The actuator 102, when activated, is configured to release the fire-suppression agent held under pressure within the pressure vessel 101. For example, the actuator 102 might be configured to release the fire-suppression agent by rupturing a frangible bulb 110 of the sprinkler head 107. Thus, for example, the actuator 102 might include a housing 111 and a pin 112. In such embodiments, when the actuator 102 is activated, the pin 112 is configured to extend from the housing 111 a sufficient distance to strike the frangible bulb 110 of the sprinkler head 107, thus rupturing the frangible bulb 110.

The wireless transmitter 103 is remote from the actuator 102, and the wireless transmitter 103 is configured to wirelessly transmit an activation signal 113, symbolized by the jagged line in FIG. 1. The wireless transmitter 103 could be, for example, a radio frequency (RF) transmitter or an infrared (IR) transmitter. Preferably, the wireless transmitter 103 utilizes coding to reduce the likelihood that a nearby transmitter, not part of the wireless fire-protection system 100, is transmitting a similar signal that may undesirably be received by the wireless receiver 104. The code may be fixed or rolling. The wireless transmitter 103 may also be configured to wirelessly transmit a test signal as described more fully below.

In this context, “remote” means at a distance of at least about 3 feet (about 1 meter) and preferably at a distance of at least about 8 feet (about 2.5 meters). Accordingly, the transmission range of the wireless transmitter 103 preferably is at least 10 feet (about 3 meters). More preferably, the range of the wireless transmitter 103 is at least 100 feet (about 30 meters). Even more preferably, the range of the wireless transmitter 103 is between about 600 feet (about 180 meters) and about 6,000 feet (about 1,800 meters).

The wireless receiver 104 is coupled to the actuator 102, such as through an electrical connection. The wireless receiver 104 is configured to wirelessly receive the activation signal 113 from the wireless transmitter 103 and, in response to the activation signal 113, send an initiate signal to the actuator 102. Thus, for example, the wireless receiver 104 could be an RF receiver or an IR receiver. In embodiments, the wireless transmitter 103 and wireless receiver 104 may communicate via specified frequency bands, such as 315 megahertz (MHz) or 433 MHz. The wireless receiver 104 may include a programmable switch that, when activated by receipt of the activation signal 113, sends an electrical signal to the actuator 102 as the initiate signal. The electrical signal may be, for example, electrical power to power the actuator 102 on.

The receiver battery 105 is coupled to the wireless receiver 104 and is configured to provide electrical power to the wireless receiver 104. Accordingly, the wireless receiver 104 preferably is not coupled to grid power. The term “grid power” as used in this specification means electrical power obtained from an electrical grid. Accordingly, the wireless receiver 104 may be operated by battery power in locations where grid power is not available or feasible, including, as examples, shipping containers, warehouses, coal mines, mobile platforms, airplane hangars, storage spaces, balconies, attics, industrial holding tanks, vehicles, and other places. Also, this feature allows the wireless receiver 104 to be installed without requiring an electrician to wire the receiver to the electrical grid.

Preferably, the receiver battery 105 is a long-life battery having a usable life of ten years or more from the date of manufacture of the battery. A long life helps to reduce maintenance costs by reducing the frequency that a battery needs to be changed. Also, the receiver battery 105 preferably is rated for a temperature range of at least covering the range from −4 degrees Fahrenheit (° F.) (about −20 degrees Celsius (° C.)) to 130° F. (about 55° C.). The receiver battery 105 may be a battery pack that includes more than one battery cell.

In embodiments, the actuator 102 may be coupled to the receiver battery 105, which is further configured to provide electrical power to the actuator 102. The coupling may be direct, or the actuator 102 may be coupled to the receiver battery 105 through the wireless receiver 104. Accordingly, the actuator 102 preferably is not coupled to grid power.

The sprinkler head 107 is coupled to the outlet 109 of the pressure vessel 101. The sprinkler head 107 is configured to disperse the fire-suppression agent when released from the pressure vessel 101. The sprinkler head 107 might include a frangible bulb 110, such as a temperature-sensitive frangible bulb 110 described above. The sprinkler head 107 could be, for example, a sprinkler head 107 of the type used in conventional water fire-suppression systems.

The visual indicator 108 is preferably at the wireless receiver 104 and may include a light emitting diode (LED). The visual indicator 108 may be configured to indicate a ready status in response to a test signal received by the wireless receiver 104. The ready status may confirm, for example, that the wireless receiver 104 and actuator 102 are connected, powered, and in range to receive an activation signal 113 from the wireless transmitter 103. Thus, for example, the wireless transmitter 103 may include an operator-accessible button or other switch for an operator to initiate the test signal. When initiated, the test signal may be sent to one or more wireless receivers 104 within range of the wireless transmitter 103. The wireless receiver 104 may then, for example, process the test signal and provide feedback by, for example, activating the visual indicator 108. Alternatively, or in addition, the visual indicator 108 may be configured to indicate a charge status of the battery coupled to the wireless receiver 104.

The transmitter battery 106 may be coupled to the wireless transmitter 103 and configured to provide electrical power to the wireless transmitter 103. The features and preferred operating conditions of the transmitter battery 106 may be the same as those noted above for the receiver battery 105. Specifically, the transmitter battery 106 may be a long-life battery having a usable life of ten years or more from the date of manufacture of the battery. Also, the transmitter battery 106 preferably is rated for a temperature range of at least covering the range from −4° F. (about −20° C.) to 130° F. (about 55° C.). The transmitter battery 106 may be a battery pack that includes more than one battery cell.

As illustrated in FIG. 1, the pressure vessel 101, the actuator 102, and the wireless receiver 104 may be physically connected into a single, structural unit, referred to here as a fire-suppression unit. In embodiments, the fire-suppression unit may also include one or more of the receiver battery 105, the sprinkler head 107, and the visual indicator 108. Hence, the fire-suppression unit may be installed by an operator in one piece.

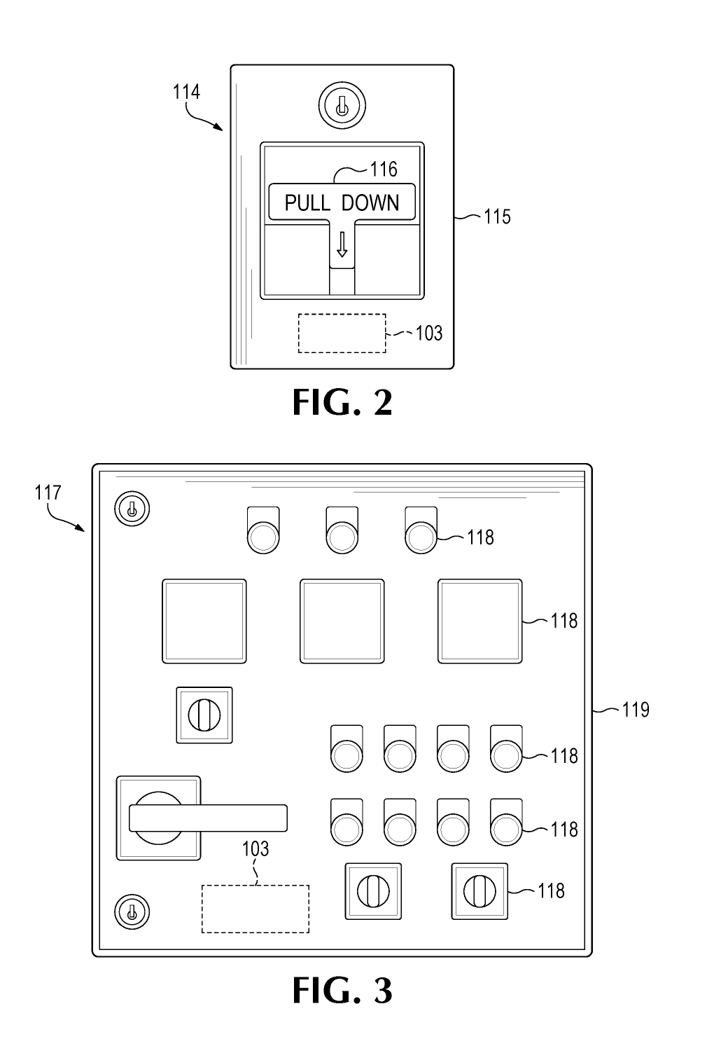

FIG. 2 is a diagram of an example of a fire-alarm pull-station 114. In embodiments, the wireless transmitter 103 may be part of a fire-alarm pull-station 114. A typical fire-alarm pull-station 114 includes, for example, a wall box 115 having a T-handle 116 or other switching mechanism that is activated by an operator, such as by pulling down on the T-handle 116 or manually moving the switching mechanism. In such embodiments, the wireless transmitter 103 may be, for example, located within the wall box 115 and configured to wirelessly transmit the activation signal 113 when, for example, the T-handle 116 is pulled down by the operator or other switching mechanism is manually moved by the operator.

FIG. 3 is a diagram of an example of a fire control panel 117. In embodiments, the wireless transmitter 103 may be part of a fire control panel 117. A typical fire control panel 117 includes, for example, gauges, switches, buttons, and status indicators 118 pertinent to the monitoring and control of fire hazards, each located within a housing 119. In such embodiments, the wireless transmitter 103 may be, for example, located within the housing 119 and configured to wirelessly transmit the activation signal 113 when, for example, the operator activates a switch or button of the fire control panel 117. Alternatively, the wireless transmitter 103 may be automatically activated by a logic device coupled to or within the fire control panel 117 and based on fire control data monitored by the fire control panel 117.

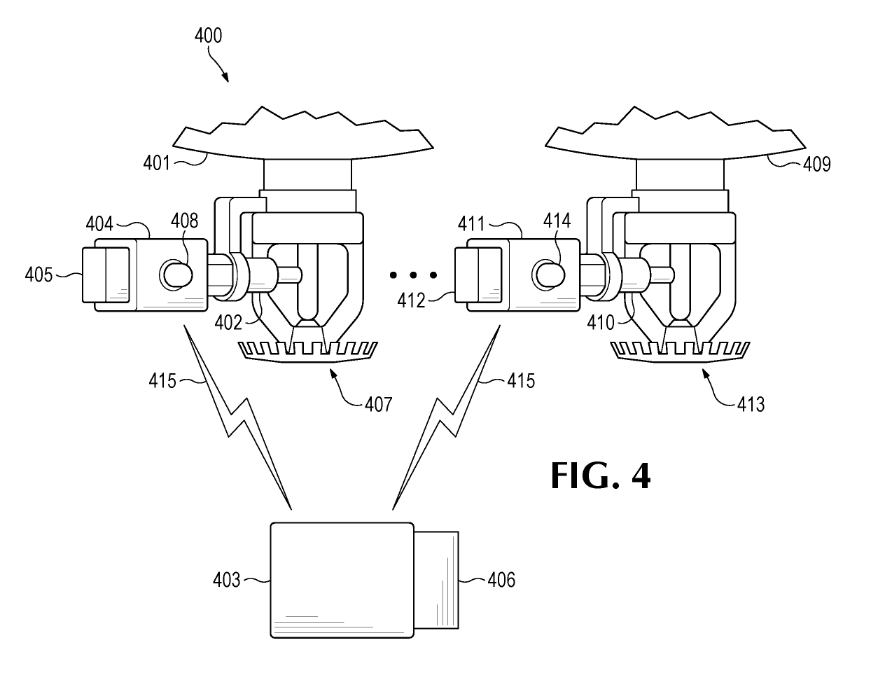

FIG. 4 is a diagram of a wireless fire-protection system. In embodiments, the transmitter may be connected to more than one actuator. Hence, as illustrated in FIG. 4, a wireless protection system 400 may include a first pressure vessel 401, a first actuator 402, a wireless transmitter 403, a first wireless receiver 404, a first receiver battery 405, a transmitter battery 406, a first sprinkler head 407, and a first visual indicator 408 or LED. Each of these may be generally as described above for the corresponding components of FIGS. 1-3.

In addition, the wireless protection system 400 may include a second pressure vessel 409, a second actuator 410, a second wireless receiver 411, a second receiver battery 412, a second sprinkler head 413, and a second visual indicator 414 or LED. Each of these also may be generally as described above for the corresponding components of FIGS. 1-3.

As illustrated in FIG. 4, the wireless transmitter 403 is remote from the first actuator 402 and the second actuator 410, the first actuator 402 may be remote from the second actuator 410. The wireless transmitter 403 is configured to wirelessly transmit an activation signal 415. The first wireless receiver 404 and the second wireless receiver 411 are each configured to wirelessly receive the activation signal 415 from the wireless transmitter 403. Hence, the wireless transmitter 403 may transmit the activation signal 415 to more than one wireless receiver in the wireless fire-protection system 400.

Accordingly, a method of using the wireless fire-protection system may include: wirelessly transmitting an activation signal by a wireless transmitter that is remote from an actuator at an outlet of a pressure vessel, the pressure vessel holding under pressure a fire-suppression agent; wirelessly receiving, at a battery-powered wireless receiver coupled to the actuator, the activation signal from the wireless transmitter; activating, by the wireless receiver in response to the activation signal, the actuator; and releasing, through the outlet of the pressure vessel, the fire-suppression agent. In embodiments, a method of using the wireless fire-protection system may also include after activating the actuator, rupturing, by the actuator, a frangible bulb of a sprinkler head coupled to the outlet of the pressure vessel.

### EXAMPLES

Illustrative examples of the disclosed technologies are provided below. An embodiment of the technologies may include one or more, and any combination of, the examples described below.

Example 1 includes a system comprising: a pressure vessel; an actuator at an outlet of the pressure vessel, the actuator configured to, when activated, release fire-suppression agent held under pressure within the pressure vessel; a wireless transmitter remote from the actuator, the wireless transmitter configured to wirelessly transmit an activation signal; a wireless receiver coupled to the actuator, the wireless receiver configured to wirelessly receive the activation signal from the wireless transmitter; and a battery coupled to the wireless receiver and configured to provide electrical power to the wireless receiver.

Example 2 includes the system of Example 1, further comprising a sprinkler head coupled to the outlet of the pressure vessel, the sprinkler head being configured to disperse the fire-suppression agent when released from the pressure vessel.

Example 3 includes the system of Example 2, in which the actuator is configured to release a fire-suppression agent held under pressure within the pressure vessel by rupturing a frangible bulb of the sprinkler head.

Example 4 includes the system of any of Examples 1-3, further comprising a visual indicator at the wireless receiver, the visual indicator configured to indicate a ready status or an unready status in response to a test signal received by the wireless receiver.

Example 5 includes the system of any of Examples 1-4, further comprising a visual indicator at the wireless receiver, the visual indicator configured to indicate a charge status of the battery coupled to the wireless receiver.

Example 6 includes the system of any of Examples 1-5, further comprising a transmitter battery coupled to the wireless transmitter and configured to provide electrical power to the wireless transmitter.

Example 7 includes the system of any of Examples 1-6, in which the wireless receiver is not coupled to grid power.

Example 8 includes the system of any of Examples 1-7, in which the wireless transmitter is part of a fire control panel.

Example 9 includes the system of any of Examples 1-8, in which the wireless transmitter is part of a fire-alarm pull-station.

Example 10 includes the system of any of Examples 1-9, further comprising: a second pressure vessel; a second actuator at an outlet of the second pressure vessel, the second actuator configured to, when activated, release fire-suppression agent held under pressure within the second pressure vessel; a second wireless receiver coupled to the second actuator, the second wireless receiver configured to wirelessly receive the activation signal from the wireless transmitter; and a second battery coupled to the second wireless receiver and configured to provide electrical power to the second wireless receiver.

Example 11 includes the system of any of Examples 1-10, in which the fire-suppression agent is a dry-chemical agent.

Example 12 includes the system of any of Examples 1-10, in which the fire-suppression agent is a fire-suppression gel.

Example 13 includes a system comprising: a pressure vessel holding a fire-suppression agent under pressure; an actuator at an outlet of the pressure vessel, the actuator configured to, when activated by an initiate signal, release the fire-suppression agent from the pressure vessel; a sprinkler head coupled to the outlet of the pressure vessel, the sprinkler head configured to disperse the fire-suppression agent when released from the pressure vessel; a wireless transmitter remote from the actuator, the wireless transmitter configured to wirelessly transmit an activation signal; a wireless receiver coupled to the actuator, the wireless receiver configured to wirelessly receive the activation signal from the wireless transmitter and, in response to the activation signal, send the initiate signal to the actuator; and a battery coupled to the wireless receiver and configured to provide electrical power to the wireless receiver.

Example 14 includes the system of Example 13, in which the sprinkler head further comprises a temperature-sensitive frangible bulb, and in which the actuator is configured to release the fire-suppression agent from the pressure vessel by mechanically rupturing the frangible bulb of the sprinkler head.

Example 15 includes the system of any of Examples 13-14, in which the fire-suppression agent is a dry-chemical agent.

Example 16 includes the system of any of Examples 13-14, in which the fire-suppression agent is a fire-suppression gel.

Example 17 includes a method comprising: wirelessly transmitting an activation signal by a wireless transmitter that is remote from an actuator at an outlet of a pressure vessel, the pressure vessel holding under pressure a fire-suppression agent; wirelessly receiving, at a battery-powered wireless receiver coupled to the actuator, the activation signal from the wireless transmitter; activating, by the wireless receiver in response to the activation signal, the actuator; and releasing, through the outlet of the pressure vessel, the fire-suppression agent.

Example 18 includes the method of Example 17, further comprising, after activating the actuator, rupturing, by the actuator, a frangible bulb of a sprinkler head coupled to the outlet of the pressure vessel.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular aspect or embodiment, that feature can also be used, to the extent possible, in the context of other aspects and embodiments.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Although specific embodiments have been illustrated and described for purposes of illustration, it will be understood that various modifications may be made without departing from the spirit and scope of the disclosure. Accordingly, the invention should not be limited except as by the appended claims.

1. A system comprising:
a pressure vessel;
an actuator at an outlet of the pressure vessel, the actuator configured to, when activated, release fire-suppression agent held under pressure within the pressure vessel;
a wireless transmitter remote from the actuator, the wireless transmitter configured to wirelessly transmit an activation signal;
a wireless receiver coupled to the actuator, the wireless receiver configured to wirelessly receive the activation signal from the wireless transmitter; and
a battery coupled to the wireless receiver and configured to provide electrical power to the wireless receiver.

2. The system of claim 1, further comprising a sprinkler head coupled to the outlet of the pressure vessel, the sprinkler head being configured to disperse the fire-suppression agent when released from the pressure vessel.

3. The system of claim 2, in which the actuator is configured to release a fire-suppression agent held under pressure within the pressure vessel by rupturing a frangible bulb of the sprinkler head.

4. The system of claim 1, further comprising a visual indicator at the wireless receiver, the visual indicator configured to indicate a ready status or an unready status in response to a test signal received by the wireless receiver.

5. The system of claim 1, further comprising a visual indicator at the wireless receiver, the visual indicator configured to indicate a charge status of the battery coupled to the wireless receiver.

6. The system of claim 1, further comprising a second battery coupled to the wireless transmitter and configured to provide electrical power to the wireless transmitter.

7. The system of claim 1, in which the wireless receiver is not coupled to grid power.

8. The system of claim 1, in which the wireless transmitter is part of a fire control panel.

9. The system of claim 1, in which the wireless transmitter is part of a fire-alarm pull-station.

10. The system of claim 1, further comprising:
a second pressure vessel;
a second actuator at an outlet of the second pressure vessel, the second actuator configured to, when activated, release fire-suppression agent held under pressure within the second pressure vessel;
a second wireless receiver coupled to the second actuator, the second wireless receiver configured to wirelessly receive the activation signal from the wireless transmitter; and
a second battery coupled to the second wireless receiver and configured to provide electrical power to the second wireless receiver.

11. The system of claim 1, in which the fire-suppression agent is a dry-chemical agent.

12. The system of claim 1, in which the fire-suppression agent is a fire-suppression gel.

13. A system comprising:
a pressure vessel holding a fire-suppression agent under pressure;
an actuator at an outlet of the pressure vessel, the actuator configured to, when activated by an initiate signal, release the fire-suppression agent from the pressure vessel;
a sprinkler head coupled to the outlet of the pressure vessel, the sprinkler head configured to disperse the fire-suppression agent when released from the pressure vessel;
a wireless transmitter remote from the actuator, the wireless transmitter configured to wirelessly transmit an activation signal;
a wireless receiver coupled to the actuator, the wireless receiver configured to wirelessly receive the activation signal from the wireless transmitter and, in response to the activation signal, send the initiate signal to the actuator; and
a battery coupled to the wireless receiver and configured to provide electrical power to the wireless receiver.

14. The system of claim 13, in which the sprinkler head further comprises a temperature-sensitive frangible bulb, and in which the actuator is configured to release the fire-suppression agent from the pressure vessel by mechanically rupturing the frangible bulb of the sprinkler head.

15. The system of claim 13, in which the fire-suppression agent is a dry-chemical agent.

16. The system of claim 13, in which the fire-suppression agent is a fire-suppression gel.

17. A method comprising:
wirelessly transmitting an activation signal by a wireless transmitter that is remote from an actuator at an outlet of a pressure vessel, the pressure vessel holding under pressure a fire-suppression agent;
wirelessly receiving, at a battery-powered wireless receiver coupled to the actuator, the activation signal from the wireless transmitter;
activating, by the wireless receiver in response to the activation signal, the actuator; and
releasing, through the outlet of the pressure vessel, the fire-suppression agent.

18. The method of claim 17, further comprising, after activating the actuator, rupturing, by the actuator, a frangible bulb of a sprinkler head coupled to the outlet of the pressure vessel.
